(19) United States
(12) Patent Application Publication
(10) Pub. No.: US 2005/0100089 A1
(43) Pub. Date: May 12, 2005

(54) Moving image data controlling apparatus and method

(75) Inventors: Ichiro Nakano, Kawasaki-shi (JP); Yasufumi Nakamura, Kawasaki-shi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/998,011

(22) Filed: Nov. 29, 2004

Related U.S. Application Data
(62) Division of application No. 09/248,111, filed on Feb. 11, 1999.

(30) Foreign Application Priority Data
Jun. 30, 1998 (JP) 10-185377

(51) Int. Cl. H04N 7/12

(52) U.S. Cl. 375/240.01

(57) ABSTRACT

The present invention introduces a technique capable of adding display effects such as shadings and mosaic to a digital moving image easily. First, digital moving image data containing frames and area information defined for each frame are respectively encoded, and the area information is synchronized and multiplexed with each frame of the digital moving image stream so as to be outputted as one data. In reproducing the moving image encoded in this way, each data is demultiplexed, and the area information and the digital moving image stream are decoded by the decoding unit. Then, as to the finally-obtained digital moving image stream for display, the data changing unit executes data change to pixels at specific part of the frame designated by the area information, thereby so-called mosaic or the like is applied to the digital moving image data.

### BACKGROUND OF THE INVENTION

1. Field of the Invention

The present invention relates to a moving image data controlling apparatus and a method thereof, particularly, to an apparatus for recording and reproducing a digital moving image and a method thereof. More particularly, the present invention relates to a technique applying a display effect such as displaying in mosaic and making shadings to a specific area in an image when a personal computer or the like displays a digital moving image.

2. Description of the Related Art

As a conventional technique, it is known that, when display of an image is changed such as scrambling in shadings or in mosaic, pixel data is corrected while image source is digitized and is encoded into a digital image.

In the above-described technique, it is necessary to change data for each of pixels constituting the image, therefore, there is a trouble, namely, it needs a complicated procedure. Further, a pixel value is changed once, therefore, it is impossible to make the display effect effective or ineffective according to an instruction and a password input from an user, and so on.

### SUMMARY OF THE INVENTION

It is an object of the present invention to provide a technique applying a display effect such as shadings and mosaic to a digital moving image, and to provide a technique capable of dynamically making the display effect effective or ineffective at real time according to an input from an user.

The present invention introduces the followings in order to achieve the above-described objects.

That is, the present invention introduces a moving image data controlling apparatus comprising a moving image source input unit for inputting moving image data; an information input unit for inputting control information designating a processing for the moving image data inputted through said moving image source input unit; and a data integrating unit for integrating the moving image data inputted through said moving image source input unit with the control information inputted through said information input unit.

More concretely, a moving image data controlling apparatus comprises a digital moving image source input unit for inputting digital moving image data containing plural data of a predetermined image unit; an area information input unit for inputting area information defined for each predetermined image unit of the digital moving image data inputted through said moving image source input unit; and a data integrating unit for integrating the area information inputted through said area information input unit, as additional information for all pixels in each predetermined image unit of the digital moving image data inputted through said digital moving image source input unit, with the digital moving image data.

The present invention also introduces a moving image data storing method comprising: a step of inputting moving image data; a step of inputting control information designating a processing for the inputted moving image data; a step of integrating the inputted moving image data with the control information; and a step of storing the moving image data and the control information which are integrated.

The present invention also introduces a computer readable medium storing a program making computer function as a moving image source input unit for inputting moving image data; an information input unit for inputting control information designating a processing for the moving image data inputted through said moving image source input unit; and a data integrating unit for integrating the moving image data inputted through said moving image source input unit with the control information inputted through said information input unit.

Further, the present invention introduces a moving image data controlling apparatus comprising a moving image source input unit for inputting moving image data; an information input unit for inputting control information designating a processing for the moving image data inputted through said moving image source input unit; and a data changing unit for executing data change designated by the control information to a moving image data stream obtained from the moving image source input unit.

In this case, the data changing unit may execute the data change while said moving image data stream is reproduced.

The moving image data controlling apparatus may further comprise an instructing unit for instructing the data changing unit whether or not the data change is executed and/or how to change data when the data change is executed in accordance with an input from an user or from another event.

The present invention also introduces a moving image data reproducing method comprising a step of inputting moving image data; a step of inputting control information designating a processing for the moving image data; and a step of executing the processing designated by the control information to a moving image data stream obtained from the inputted moving image data.

In this case, the data change may be executed while said moving image data stream is reproduced.

An instruction from an user or another event may be inputted, and an existence of the data change and/or a change content may be decided in accordance with the inputted instruction or the inputted event.

The present invention also introduces a computer readable medium storing a program making computer function as; a moving image source input unit for inputting moving image data; an information input unit for inputting control information designating a processing for the moving image data inputted through the moving image source input unit; and a data changing unit for executing data change designated by the control information to a moving image data stream obtained from the moving image source input unit.

The present invention also introduces a moving image data controlling apparatus comprising: a digital moving image source input unit for inputting digital moving image data containing plural data of a predetermined image unit; an area information input unit for inputting area information defined for each predetermined image unit of the digital moving image data inputted through said moving image source input unit; and a data changing unit for obtaining a digital moving image stream from the moving image source input unit and for executing data change to pixels of the digital moving image data designated by the control information in each predetermined image unit of the digital moving image stream.

In this case, the moving image data controlling apparatus may further comprise an instructing unit for instructing the data changing unit whether or not a pixel value is changed and/or how to change the pixel value when the pixel value is changed.

The present invention introduces a moving image data controlling method comprising: a step of inputting digital moving image data containing plural data of a predetermined image unit; a step of inputting area information defined for each predetermined image unit of the inputted digital moving image data; a step of obtaining a digital moving image stream from the digital moving image data; and a step of executing data change to pixels of the digital moving image data designated by the control information in each predetermined image unit of the digital moving image stream.

In this method, it may be instructed whether or not a pixel value is changed and/or how to change the pixel value when the pixel value is changed.

The present invention also introduces a computer readable medium storing a program making computer function as; a digital moving image source input unit for inputting digital moving image data containing plural data of a predetermined image unit; an area information input unit for inputting area information defined for each predetermined image unit of the digital moving image data inputted through the moving image source input unit; and a data changing unit for obtaining a digital moving image stream from the moving image source input unit and for executing data change to a pixel of the digital moving image data designated by the control information in each predetermined image unit of the digital moving image stream.

### BRIEF DESCRIPTION OF THE DRAWINGS

Other objects and advantages of the present invention will become apparent during the following discussion conjunction with the accompanying drawings, in which:

FIG. 1 is a block diagram showing an encoder according to an embodiment of the present invention;

FIG. 2 is a block diagram showing an decoder according to an embodiment of the present invention;

FIG. 3 is a block diagram showing a decoder according to another embodiment;

FIG. 4 is a view showing a concrete example of an encoder;

FIG. 5 is a view showing a concrete example of a decoder;

FIG. 6 is a view showing another concrete example of a decoder;

FIG. 7 is a view showing an user graphical interface of an instructing unit;

FIG. 8 is a flowchart showing a process according to an embodiment; and

FIG. 9 is a view showing a sample of a bitmap.

### DETAILED DESCRIPTION OF THE PREFERRED EMBODIMENT

Hereinafter, concrete explanations will be given of embodiments according to the present invention.

### Embodiments

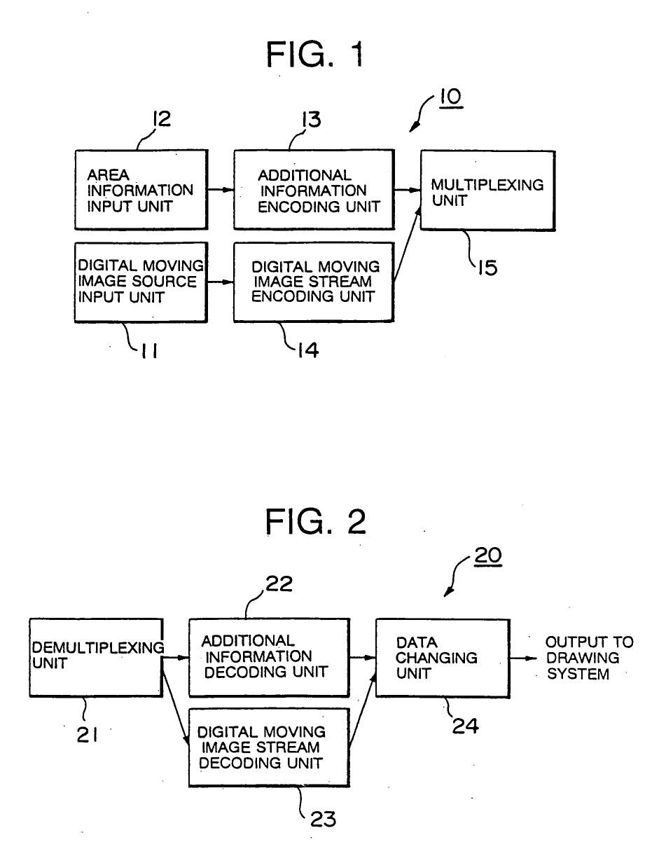

FIG. 1 shows an encoder according to an embodiment of the present invention.

As shown in FIG. 1, an encoder 10 for a moving image is provided with a digital moving image source input unit 11, an area information input unit 12, an additional information encoding unit 13, a digital moving image stream encoding unit 14 and a multiplexing unit 15.

The digital moving image source input unit 11 receives digital moving image data containing moving image units of data. Concretely, the digital moving image source input unit 11 receives digital data containing frames as predetermined image units.

The area information input unit 12 receives area information defined for each predetermined image unit of the inputted digital moving image. Concretely, the area information input unit 12 receives the area information corresponding to each frame of the digital moving image.

The additional information encoding unit 13 encodes the area information inputted through the area information input unit 12 as additional information for all pixels in each predetermined image unit of the digital moving image source inputted through the digital moving image source input unit 11.

The moving image encoding unit 14 encodes digital moving image stream according to the digital moving image data inputted through the digital moving image source input unit 11.

Concretely, a plurality of digital moving image frames formed as time passes are inputted through the digital moving image source input unit 11, and the moving image encoding unit 14 encodes these digital moving image frames into a digital moving format such as MPEG-1 Video.

The multiplexing unit 15 synchronizes and multiplexes the additional information with each predetermined fixed image unit of the digital moving image stream based on both outputs from the additional information encoding unit 13 and the moving image encoding unit 14, and outputs them as one piece of data.

The area information, for example, is data obtained by sequentially arranging bit maps as time passes, in which 1 bit is allocated to each pixel of the frame and which has an image size equal to the frame size of the digital moving image. The area information is compressed in a format such as RLE (run-length encode format) and is encoded by the additional information encoding unit 13.

FIG. 2 shows a decoder used in order to display the moving image data encoded by the encoder 10 shown in FIG. 1, the moving image data having additional information for each pixel.

The encoder 20 is provided with a demultiplexing unit 21, an additional information decoding unit 22, a moving image decoding unit 23 and a data changing unit 0.24.

The demultiplexing unit 21 demultiplexes the multiplexed digital moving image data so as to obtain an encoded additional information and an encoded digital moving image stream data. In other words, the demultiplexing unit 21 separates data encoded by the encoder 10 shown in FIG. 1 into an encoded additional information stream and an encoded digital moving image stream.

The additional information decoding unit 22 decodes the encoded additional information. Concretely, the additional information decoding unit 22 outputs area data for each frame of the digital moving image stream.

The moving image decoding unit 23 decodes the encoded digital moving image stream data, and outputs each frame of the digital moving image.

The data changing unit 24 receives the additional information outputted from the additional information decoding unit 22 and the digital moving image stream outputted from the moving image decoding unit 23, and changes data for a pixel of the digital moving data designated by the area information in each predetermined moving image unit of this digital moving image stream. Concretely, the data changing unit 24 obtains frame data outputted from the digital moving stream decoding unit 23 and area data outputted from the additional information decoding unit 22 corresponding to this frame data, and changes a pixel value of the corresponding area in the frame designated by the additional information.

The frame data outputted from the data changing unit 24 is outputted into a display memory such as VRAM at a constant rate as time passes. In this way, a pixel value of a specified area in an digital moving image is changed, and outputted.

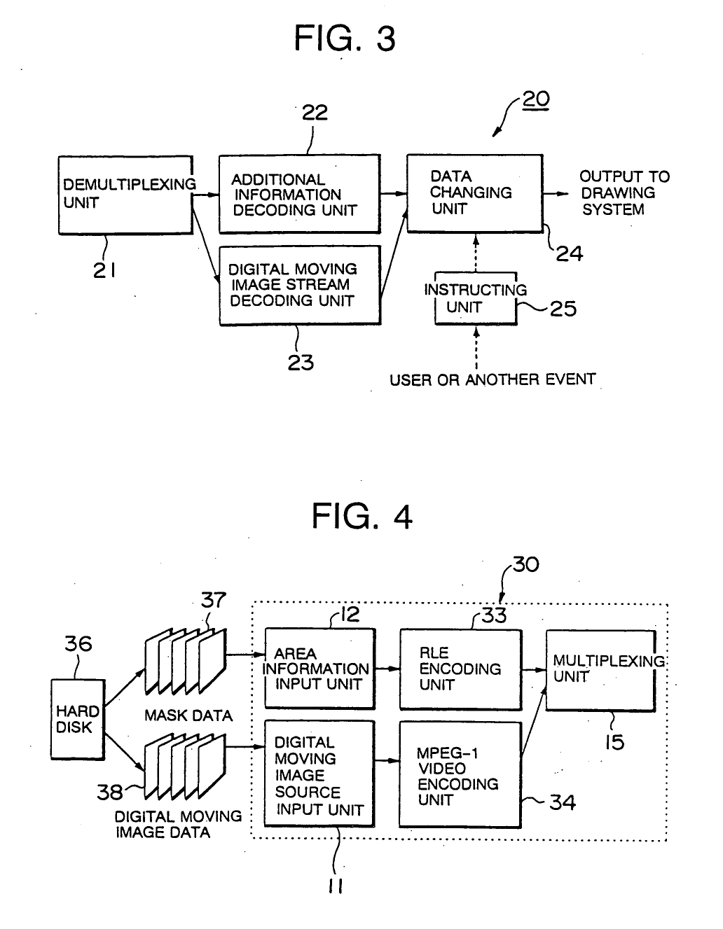

As shown in FIG. 3, an encoder may be provided with an instructing unit 25 instructing the data changing unit 24 at real time whether or not a pixel value is changed in accordance with an input from an user or from another event and/or how the pixel value is changed when the pixel value is changed.

In other words, the instructing unit 25 detects an user input or an event, and sends a signal instructing the data changing unit 24 how to change data when data is really changed in accordance with the detected user input or event.

Next, explanations will be given of operation of the encoder 10 and the decoder 20.

In FIG. 1, the digital moving image source input unit 11 receives digital moving image data consisting of predetermined units of data, such as frames and pictures.

The area information input unit 12 receives the area information defined for each predetermined image unit of the inputted digital moving image. This is separately carried out regardless of before and after inputting digital moving image source.

In other words, area information is defined in correspondence with the predetermined image unit (such as frame), and is inputted.

Then, the additional information encoding unit 13 encodes area information inputted through the area information input unit 12 into additional information for all pixels of each predetermined image unit in the digital moving image source inputted through the digital moving image source input unit 11.

The moving image encoding unit 14 encodes the digital moving image stream according to the digital moving image data inputted through the digital moving image source input unit 11.

The multiplexing unit 15 multiplexes both outputs from the additional information encoding unit 13 and the moving image encoding unit 14 so as to output one by synchronizing the additional information with each predetermined image unit of the digital moving image stream.

With this procedure, encoding of the moving image is finished.

When the moving image encoded in the above-described procedure is reproduced, the moving image data having additional information every encoded pixel is displayed.

In FIG. 2, the demultiplexing unit 21 demultiplexes the multiplexed digital moving image data, and obtains the encoded additional information and the encoded digital moving image stream data.

Then, the additional information decoding unit 22 decodes the encoded additional information. The moving image decoding unit 23 decodes the encoded digital moving image stream data.

As a result, the data changing unit 24 obtains the area information outputted from the additional information decoding unit 22 and the digital moving image stream outputted from the moving image decoding unit 23, and changes data for a pixel of the digital moving image designated by the area information in each predetermined image unit of this digital moving image stream.

In this way, the held digital moving image data is not changed, but digital moving image data for display is changed in the display step after decoding.

As shown in FIG. 3, the instructing unit 25 controls the data changing unit 24. In other words, the instructing unit 25 instructs the data changing unit 24 at real time whether or not the pixel value is changed in accordance with an input from the user or another event and/or how to change the pixel value when the pixel value is changed.

Accordingly, it is possible to determine whether or not the pixel value is changed, and it is possible to easily obtain the original data which is not changed.

### Concrete Examples

Concrete explanations will be given of the above-described embodiments.

FIG. 4 is a view showing a concrete example of an encoder.

A digital moving image encoder 30 is enclosed by a broken line, and is carried out by software executed in personal computer.

The digital moving encoder 30 is connected with a hard disk 36 storing pre-produced digital moving data 38 and mask data 37 produced in correspondence with each frame of this digital moving image.

This mask data 37 consists of mask frames corresponding to respective frames of the digital moving data, has an image size (height and width) of each mask frame equal to that of a digital moving image frame, and is provided with a capacity, namely, 1 bit, for each pixel of the digital moving image. The area information input unit 12 is carried out by reading a file stored in the hard disk onto a memory by a software command, and obtains the mask data 37 as area information. The digital moving image source input unit 11 is carried out by reading a file stored in the hard disk 36 onto a memory by a software command, and obtains the digital moving data 38. Then, the mask data 37 is sent from the area information input unit 12 to the additional information encoding unit 13 via the memory as the additional information, and is compressed for each frame.

The additional information encoding unit 13 in FIG. 1 corresponds to a RLE encoding unit 33 in FIG. 4, which executes the RLE compression with a software algorithm. The moving image encoding unit 14 in FIG. 1 corresponds to the MPEG-1 Video encoding unit 34 in FIG. 4, which executes the MPEG-1 Video encoding by the software algorithm. The digital image data 38 is sent from the digital moving image source input unit 11 to the encoding unit 34 via the memory, and is compressed in the MPEG-1 Video format.

The multiplexing unit 15 receives the RLE-compressed mask data outputted from the RLE encoding unit 33 and the data compressed in the MPEG-1 Video format and outputted from the MPEG-1 Video encoding unit 34, and multiplexes both data by a software algorithm.

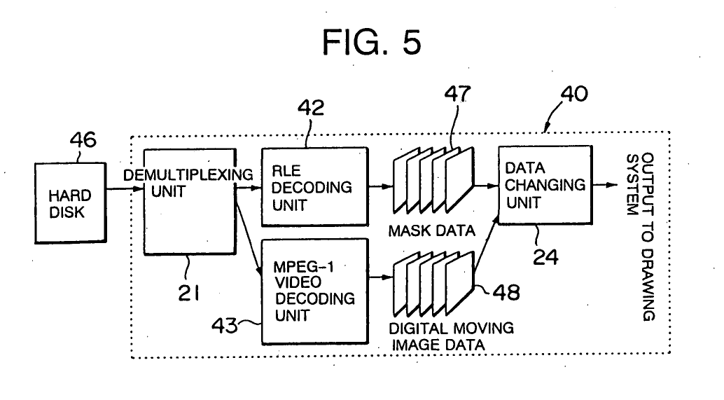

FIG. 5 shows concrete example of a decoder.

As shown in FIG. 5 a decoder 40 surrounded with a broken line is carried out with software executed in personal computer.

The digital moving image decoder 40 is connected with a hard disk 46 storing the digital moving image data produced by the encoder 30 shown in FIG. 4.

The demultiplexing unit 21 separates the digital image data inputted from the hard disk 46 to the decoder 40 into the RLE-compressed additional information and image data in the MPEG-1 Video format, and sends them to the RLE decoding unit 42 and the MPEG-1 Video decoding unit 43, respectively.

The RLE decoding unit 42 decodes the additional information so as to produce a mask data 47, and the MPEG-1 Video decoding unit 43 decodes the image data so as to produce a digital data 48 for display.

The data changing unit 24 receives the mask data 47 and the digital moving image data 48, applies a predetermined conversion to a pixel value designated by the mask data 47, and outputs an image of the converted digital moving image to a drawing device. In this way, an image effect such as “mosaic” is generated at a predetermined area in the digital moving image. Pixel values may be changed so as to generate “mosaic” or another image effect. For example, a pixel value of a specific area may be changed so as to generate a status like radiating a reflected light.

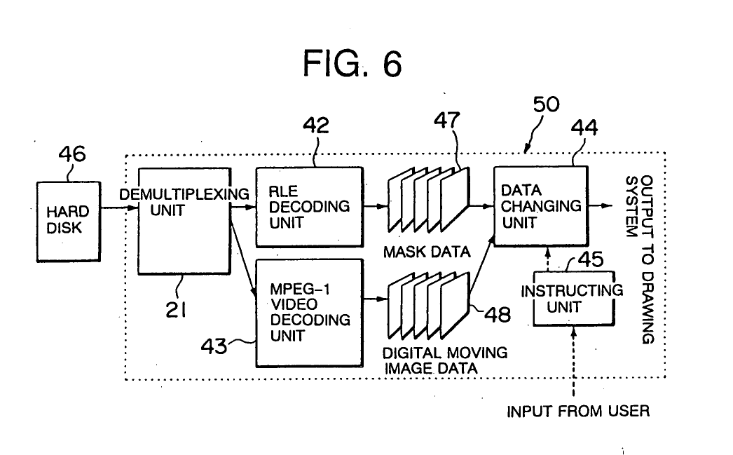

Next, an explanation will be given of an decoder of another embodiment with reference to FIG. 6.

As shown in FIG. 6, a digital moving image decoder 50 surrounded with a broken line is carried out by a software executed in personal computer.

In FIG. 6, the decoder 50 is similar with the decoder 40 in FIG. 5 expect a data changing unit 44 and an instructing unit 45, therefore, the same numerals are given to other units in the decoder 50 and no explanation is given thereof.

The instructing unit 45 accepts an input from an user's mouse, and instructs the data changing unit 44 how to change the specified pixel value with the additional information in the frame data of the moving image.

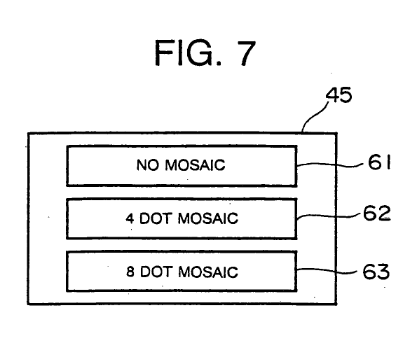

More detailed explanations will be given with reference to FIG. 7.

FIG. 7 shows a graphical user interface of the instructing unit 45 in FIG. 6, which is a dialog box displayed on a screen.

As shown in FIG. 7, the instructing unit 45 consists of graphical buttons 61, 62, 63. These buttons 61, 62, 63 can be selected by clicking the mouse or the like. The instructing unit 45 keeps a variable “n” inside, and the variable becomes “n=1” when the button “no mosaic” 61 is clicked, the variable becomes “n=4” when the button “4 dots mosaic” 62 is clicked, and the variable becomes “n=8” when the button “8 dots mosaic” 62 is clicked.

This variable “n” is sent to the data changing unit 44 shown in FIG. 6.

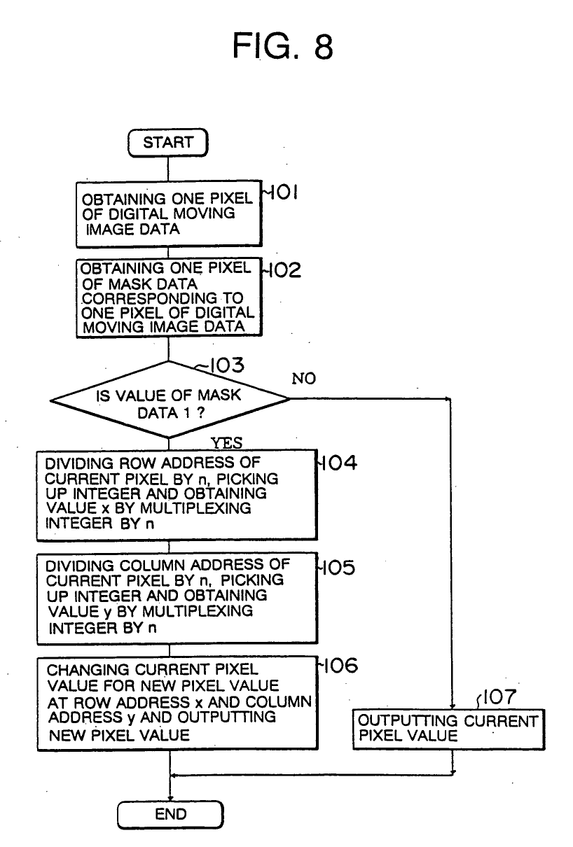

Next, explanations will be given of an action of the data changing unit 24 shown in FIGS. 5 and 6 with reference to a flowchart shown FIG. 8.

This flowchart shows an algorithm applying an image effect “4×4 dot mosaic” to a pixel of the digital moving image corresponding to the dot of the mask data when the value of the mask data is 1.

In FIG. 8, one pixel of the digital moving image data to be displayed is obtained in the step 101. Subsequently, in the step 102, the mask data corresponding to the pixel obtained in the step 101 is obtained. Then, in step 103, a value of the mask data obtained in the step 102 is checked, and the pixel value of the digital image data to be displayed is changed when the value of the mask data is 1. In the step 103, when the value of the mask data is not 1, the process is advanced to the step 107 and digital image data is outputted without changing the pixel value of the digital image data. In the steps 104, 105 and 106, the pixel value is processed, namely, when the image is divided into 4×4 dot tiles, the pixel value is changed for a pixel value at an upper left pixel in the same tile. In other words, in step 104, the row address of the current pixel is divided by n, an integer is picked up, and a value X is obtained by multiplying this integer by n. Subsequently, in the step 105, the column address of the current pixel is divided by n, an integer is picked up, and a value Y is obtained by multiplying this integer by n. Finally, the current pixel value is changed for the pixel value of the row address X and the column address Y, and the changed pixel value is outputted. In this way, the image effect “mosaic” can be applied only to the image at the area designated by mask data.

It is also possible to display another image effect such as shadings by changing the process in the steps 104, 105 and 106 into another process with the buttons 61, 62 and 63 shown in FIG. 7.

As to an algorithm carrying out “shadings”, for example, it is possible to use a method in which an arithmetic processing is performed between a value of a pixel and eight values of pixels surrounding the pixel, and a new pixel value is calculated.

An example will be explained of a method of calculating each pixel value in this case. Each pixel in a bitmap of image data includes color information and brightness information, and visibility of the whole image can be changed by changing each brightness information. The display effect “shadings” can be obtained by decreasing the visibility.

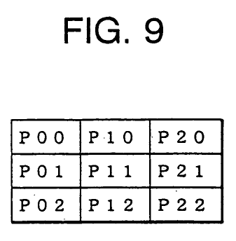

For example, FIG. 9 shows a part of one bitmap, including pixels P00, P10, P20, P01, P11, P21, P02, P12, P22. In this case, it is assumed that brightness information of each pixel is shown by PI00, PI10 . . . PI22 and each pixel value after applying “shadings” process is shown by PI′00, PI′10, . . . PI′22.

Brightness information PI′11 after applying the “shadings” process to the pixel P11 can be calculated with the following formula;
PI′11=(PI00+PI10+PI20+PI01+3×PI11+PI21+PI02+PI12+PI22)/11.

This calculation is carried out for original brightness information of all pixels, and the original brightness information is changed for the obtained brightness information, thereby obtaining “shadings” effect.

Incidentally, there is a case in that some of pixels for this calculation can not be obtained at the image data periphery. In this case, a term corresponding to lack pixel datum is excluded, and new brightness information is calculated by using a formula in which the value 11 of denominator is changed for a value obtained by subtracting a number of lacking pixels from the value 11.

For example, when pixels P00, P10, P20 can not obtained, the formula is changed as follows;
PI′11=(PI01+3×PI11+PI21+PI02+PI12+PI22)/8.

When P00, P10, P20, P01, P02 can not obtained, the formula is changed as follows;
PI′11=(3×PI11+PI21+PI12+PI22)/6.

FIG. 7 shows a flowchart of the action of the data changing unit 24 and 44 in FIGS. 5 and 6 respectively, and the algorithm of this flowchart shows that, when the value of the mask data is “1”, the “mosaic” image effect of n×n dot roughness is applied to pixels in the digital moving image corresponding to dots of this mask data. In this way, a user can watch (display) a specific area of the reproduced digital moving image in an original form, in detailed mosaic or in rough mosaic. Then, in FIG. 6, the instructing unit 45 can switch an existence of change such as “mosaic” at real time.

As above descried, in this embodiment, as to a specific area in a digital moving image, pixel data of the digital moving image outputted for display is changed without directly changing pixel data of an original digital moving image, therefore, it is possible to add display effects such as shadings or mosaic easily. An user can also dynamically switch execution/non-execution of the above-described display effects at real time. In other words, it is possible to change a display situation and a screen effect in accordance with an instruction of a user, and it is possible to apply these embodiments to any base, i.e. it is possible to usually display an image harmful to a young person uncleanly and to display the image clearly when a password is inputted.

This invention being thus described, it will be obvious that same may be varied in various ways. Such variations are not to be regarded as departure from the spirit and scope of the invention, and all such modifications would be obvious for one skilled in the art intended to be included within the scope of the following claims.

1-16. (canceled)

17. A moving image data controlling apparatus comprising:
a moving image source input unit inputting moving image data;
an information input unit inputting control information designating processing for the moving image data inputted through said moving image source input unit; and
a data processing unit executing data processing designated by the control information to a moving image data stream obtained from the moving image source input unit.

18. A moving image data controlling apparatus according to claim 17, wherein the data processing includes data changing to the moving image data

19. A moving image data controlling apparatus according to claim 17, wherein said data processing unit executes the data processing while said moving image data stream is reproduced.

20. A moving image data controlling apparatus according to claim 18, further comprising an instructing unit instructing said data processing unit whether the data change is executed and/or how to change data when the data change is executed in accordance with an input from a user or from another event.

21. A moving image data reproducing method comprising:
inputting moving image data;
inputting control information designating a processing for the moving image data; and
executing data processing designated by the control information to a moving image data stream obtained from the inputted moving image data.

22. A moving image data reproducing method according to claim 21, wherein the data processing includes data changing to the moving image data

23. A moving image data reproducing method according to claim 21, wherein the data processing is executed while said moving image data stream is reproduced.

24. A moving image data reproducing method according to claim 22, wherein an instruction from a user or another event is inputted, and an existence of the data change and/or a content change are decided in accordance with the inputted instructions or the inputted event.

25. A computer readable medium storing a program which when executed by a computer causes the computer to execute the operations comprising:
inputting moving image data;
inputting control information designating processing for the inputted moving image data; and
executing data processing designated by the control information to a moving image data stream obtained from the inputted moving image data.

26. A computer readable medium according to claim 25, wherein the data processing includes data changing to the moving image data.

27. A computer readable medium according to claim 25, wherein the data processing is executed while said moving image data stream is reproduced.

28. A computer readable medium according to claim 26, wherein an instruction from a user or another event is inputted, and an existence of the data change and/or a content change are decided in accordance with the inputted instructions or the inputted event.

29. A moving image data controlling apparatus comprising:
a digital moving image source input unit inputting digital moving image data comprising plural data of a predetermined image unit;
an area information input unit inputting area information defined for each predetermined image unit of the digital moving image data inputted through said moving image source input unit; and
a data processing unit obtaining a digital moving image stream from the moving image source input unit and executing data processing to pixels of the digital moving image data designated by the control information in each predetermined image unit of the digital moving image stream.

30. A moving image data controlling apparatus according to claim 29, further comprising:
an instructing unit instructing said data processing unit whether a pixel value is changed and/or how to change the pixel value when the pixel value is processed.

31. A moving image data controlling method comprising:
inputting digital moving image data comprising plural data of a predetermined image unit;
inputting area information defined for each predetermined image unit of the inputted digital moving image data;
obtaining a digital moving image stream from the digital moving image data; and
executing data processing to pixels of the digital moving image data designated by the control information in each predetermined image unit of the digital moving image stream.

32. A moving data controlling method according to claim 31, further comprising instructing whether a pixel value is changed and/or how to change the pixel value when the pixel value is processed.

33. A computer readable medium storing a program which when executed by a computer causes the computer to execute the operations comprising:
inputting digital moving image data comprising plural data of a predetermined image unit;
inputting area information defined for each predetermined image unit of the inputted digital moving image data; and
obtaining a digital moving image stream from the inputted digital moving image data; and
executing data processing to a pixel of the digital moving image data designated by the control information in each predetermined image unit of the digital moving image stream.

34. A computer readable medium storing a program which when executed by a computer causes the computer to execute the operations according to claim 33, further comprising instructing whether a pixel value is changed and/or how to change the pixel value when the pixel value is processed.

35. A moving image data controlling system comprising:
an encoder inputting and encoding moving image data and, separately, inputting and encoding control information indicating processing for the input moving image data, and integrating the encoded moving image data and the encoded control information; and
a decoder separating the encoded moving image data and the encoded control information, separately decoding the encoded moving image data and the encoded control information, and changing a moving image data stream obtained from the decoded moving image data based upon the decoded control information.

36. The moving image data controlling system according to claim 35, wherein the decoder comprises a data changing unit executing the changing of the moving image data stream obtained from the decoded moving image data.

37. The moving image data controlling system according to claim 36, wherein the decoder further comprises an instructing unit providing instructions about changing the moving image data stream to the data changing unit.

38. The moving image data controlling system according to claim 37, wherein the instructing unit comprises a graphical user interface comprising a dialog box displayed on a screen.

39. The moving image data controlling system according to claim 36, wherein the decoder decodes the encoded control information into mask data input to the data changing unit.

40. The moving image data controlling system according to claim 39, wherein the data changing unit receives the mask data and the decoded moving image data, applies a conversion to a pixel value designated by the mask data, and generates a mosaic in the moving image data.
